(19) United States
(12) Patent Application Publication
(10) Pub. No.: US 2010/0044940 A1
(43) Pub. Date: Feb. 25, 2010

(54) ANCHORING SYSTEM FOR ATTACHING A SHEET MATERIAL TO A MOULD-FORMED BODY AND MANUFACTURING METHOD THEREFOR

(75) Inventor: Piero Enrico Gilardi, Robbio (Pavia) (IT)

Correspondence Address: YOUNG & THOMPSON, 209 Madison Street, Suite 500, Alexandria, VA, 22314, US

(73) Assignee: TOSCANA GOMMA S.P.A., Robbio (Pavia) (IT)

(21) Appl. No.: 12/443,357

(22) PCT Filed: Sep. 26, 2007
(86) PCT No.: PCT/EP07/08376

§ 371 Date: Mar. 27, 2009

(30) Foreign Application Priority Data
Sep. 27, 2006 (IT) TO2006A000689
Dec. 20, 2006 (IT) TO2006A000909
Apr. 17, 2007 (IT) MI2007A000776

(51) Int. Cl. B25B 11/00; B23P 11/00

(52) U.S. Cl. 269/8; 29/428

(57) ABSTRACT

An anchoring system (1) attaches a sheet material (8) to a mould-formed body (7). The anchoring system (1) includes a plurality of anchoring elements (2) adapted to receive, in a snap coupling relationship, a fastening element (9) made integral with the sheet material (8). The anchoring elements (2) are fixed, in suitable positions, to an attachment element (5; 205). The anchoring elements (2) and/or the attachment element include ferrous material (4, 50; 104, 205) adapted to couple with a magnetic element carried by the mould. In this manner the anchoring system (1) can be correctly disposed in the mould and sunk into the foam material forming the body (7).

The present invention refers to an anchoring system for attaching a sheet material to a mould-formed body and a manufacturing method for said anchoring system.

In the automobile sector, seats and/or seat backs of vehicles generally comprise a supporting body of foam material, such as polyurethane foam, which is covered with upholstery of sheet material, such as cloth, imitation leather or other covering material.

The sheet covering material is held on the foam body by means of an anchoring system which comprises a plurality of hooks made integral with the foam body. Said hooks have a seat adapted to receive, in a snap coupling relationship, a fastening element made integral with the sheet covering material.

According to the prior art, said hooks are disposed in suitable positions inside the foaming mould in which the supporting body is to be formed. The foamable material is subsequently introduced into the mould, incorporating the hooks within it as it expands. The operation of positioning the hooks in the mould, which is generally performed manually, requires a lot of time and is left to the skill of the operator. Furthermore, because of the expansion of the material in the mould, the hooks often shift from the pre-set position. As a result, there is an excessively long and inexact manufacturing cycle. Clearly this situation is unacceptable in an automated continuous production process.

US patent application US 2003/0215601 discloses an anchoring system comprising a plurality of anchoring elements connected to a flexible element. Said system partially overcomes the drawback of not having to position the attaching elements individually in the mould. However, the problems of correct positioning of the anchoring elements and shifting thereof during expansion of the foam material in the mould remain.

Object of the present invention is to overcome the drawbacks of the prior art by providing an anchoring system for attaching a sheet material to a moulded body that is practical, versatile, cheap and simple to perform.

This object is achieved according to the invention with the anchoring system and the relative manufacturing method having the characteristics listed in appended independent claims 1 and 12.

Advantageous embodiments of the invention are apparent from the dependent claims.

According to the invention, the anchoring system for attaching a sheet material to a mould-formed body comprises a plurality of anchoring elements adapted to receive, in a snap coupling relationship, attachment means made integral with said sheet material. The anchoring elements are fixed, in suitable positions, to an attachment element. The anchoring elements and/or the attachment element comprise ferrous material able to couple with magnet means carried by the forming mould. In this manner the anchoring system can be correctly disposed in the mould and sunk into the foam material forming the body.

The attachment element can advantageously be a supporting strip and the ferrous material can consist of rivets which fix the anchoring elements to the supporting strip and/or clips which fix portions of supporting strips to each other.

In another embodiment the ferrous elements can be iron microspheres introduced under pressure into the attachment element and/or into the anchoring element. In this case welding can be used to connect the anchoring elements to the supporting strip and the portions of supporting strips to each other.

In a further embodiment, the attachment element is a metal rod in which the portions which accommodate the anchoring elements are flattened and the anchoring elements are welded onto said flattened portions of rod.

Further characteristics of the invention will be made clearer by the detailed description that follows, referring to purely exemplifying and therefore non-limiting embodiments thereof illustrated in the appended drawings, in which:

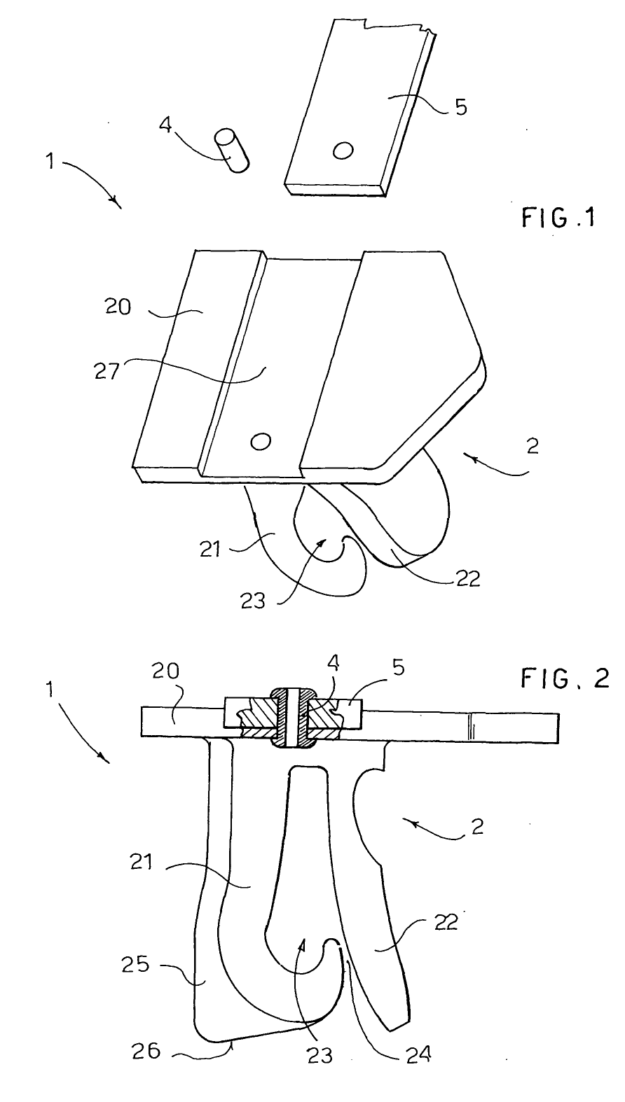

FIG. 1 is a perspective view showing exploded a hook, a supporting strip, partially broken off, and a rivet forming part of the anchoring system according to the first embodiment of the invention;

FIG. 2 is a side view of the anchoring system of FIG. 1 assembled, partially sectioned at the axis of the rivet;

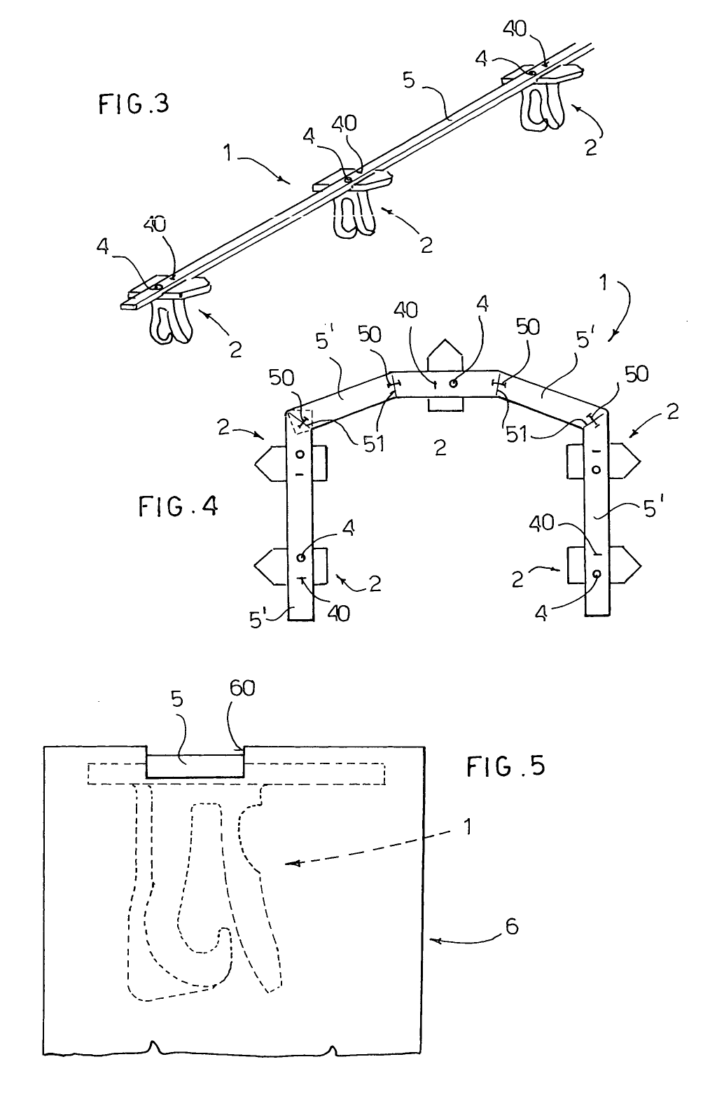

FIG. 3 is a perspective view of the anchoring system according to the invention disposed along a straight strip;

FIG. 4 is a plan view showing the anchoring system according to the invention disposed in a non-rectilinear configuration.

FIG. 5 is a diagrammatic, partially sectional side view showing the anchoring system according to the invention positioned inside a mould;

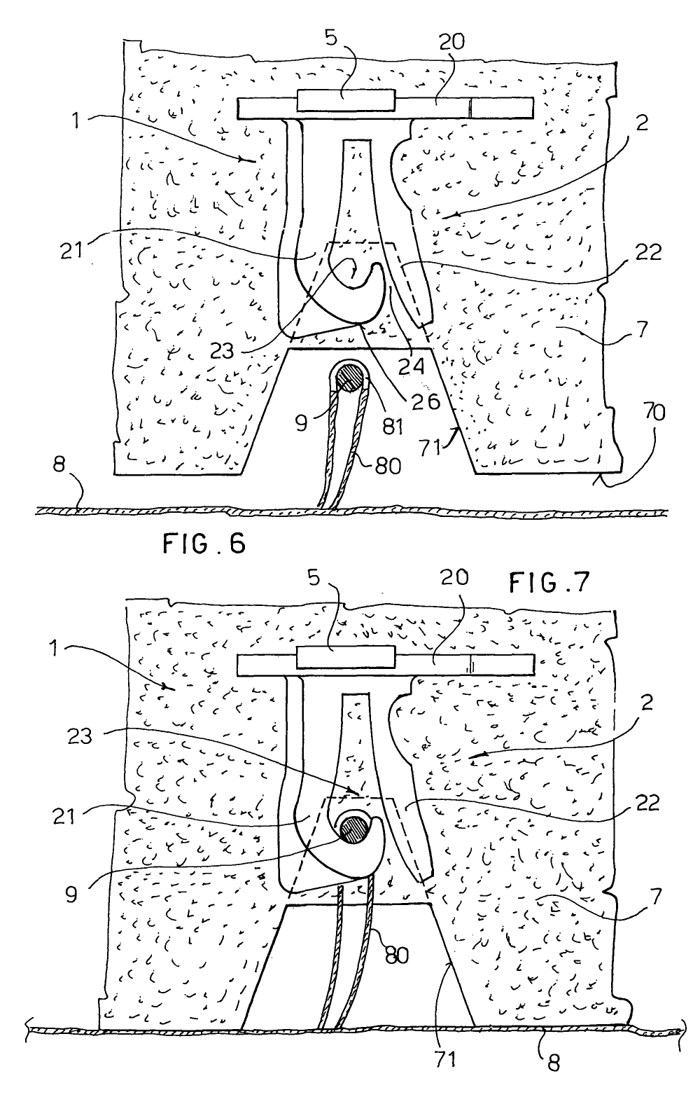

FIG. 6 is a partially sectional and broken view showing the supporting body wherein the anchoring system according to the invention is integrated and in an exploded view a sheet material provided with a fastening element for coupling with the anchoring system;

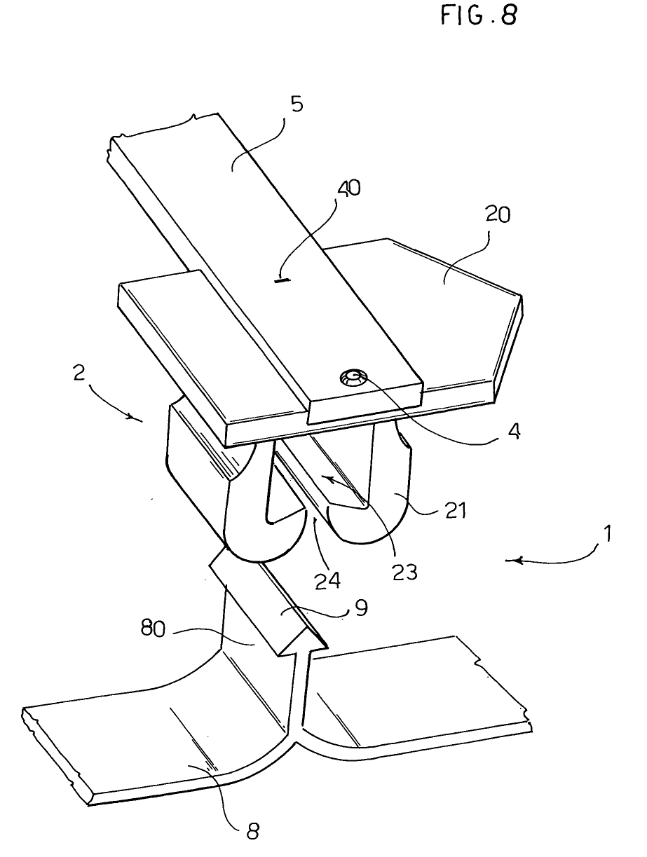

FIG. 7 is a view like FIG. 6, but showing a fastening element for the sheet material coupled to the anchoring system according to the invention;

FIG. 8 is a perspective view illustrating a variant of the anchoring system of FIGS. 6 and 7 exploded;

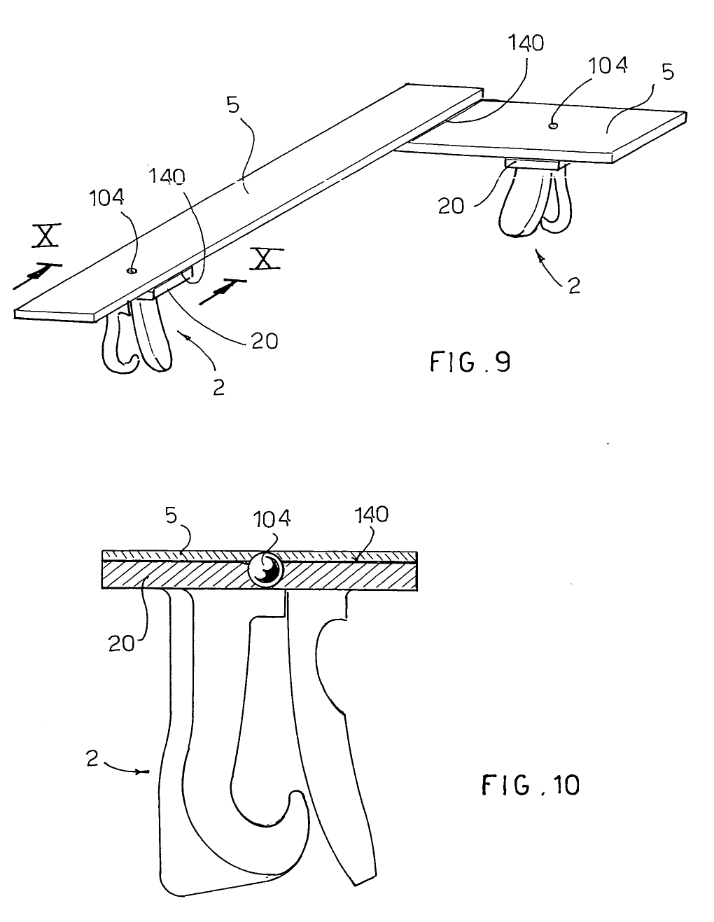

FIG. 9 is a second embodiment of the anchoring system according to the invention;

FIG. 10 is an enlarged cross sectional view taken along the plane of section X-X of FIG. 9;

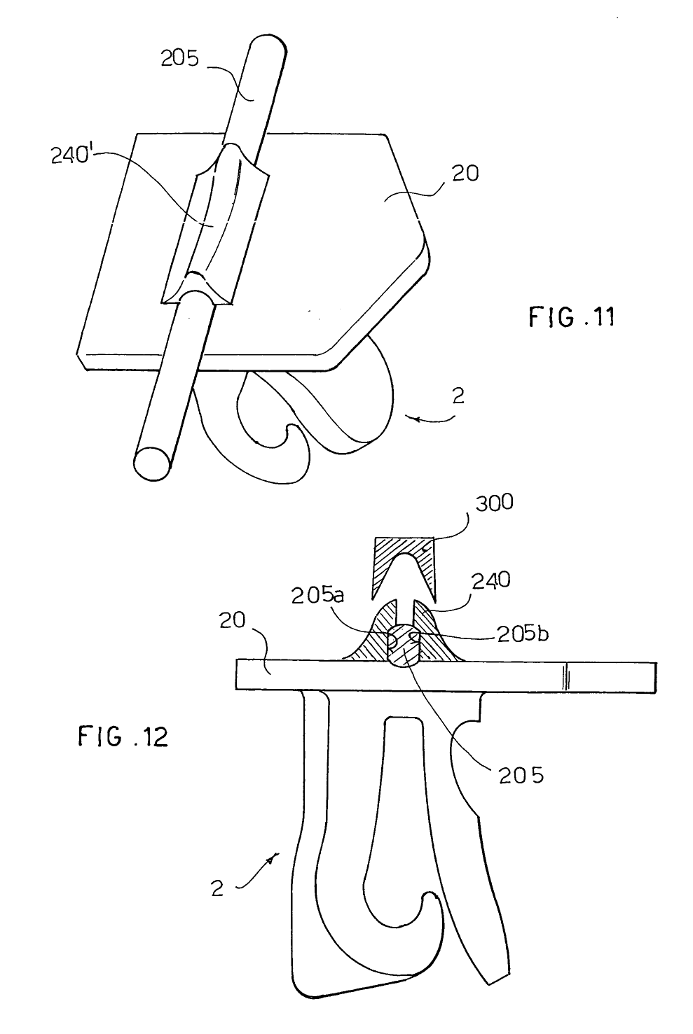

FIG. 11 is a third embodiment of the anchoring system according to the invention; and

FIG. 12 is a side view, partially in section, showing the anchoring system of FIG. 11 and a welding tool exploded.

The anchoring system according to the invention, denoted as a whole by reference numeral 1, is described with the aid of the figures.

With reference for now to FIGS. 1-4, the anchoring system 1 comprises a plurality of anchoring elements 2 fixed to an attachment element 5 in the form of a flat supporting strip 5.

With particular reference to FIGS. 1 and 2, the anchoring element 2 comprises a base plate 20 wherefrom a first hook-shaped appendix 21 and a second curved appendix 22 project. The two appendices 21 and 22 are placed side by side so as to define an snap anchoring seat 23 adapted to retain a tubular fastening element, as will be described hereunder.

With reference to FIG. 2, the anchoring seat 23 has an entrance 24 which can be widened by elastic yielding of the two appendices 21 and 22.

The first appendix 21 has an intermediate rib 25 which has an end surface 26 tapering toward the entrance 24. The tapered surface 26 acts as an entry guide for the tubular fastening element which is guided toward the entrance 24 of the snap anchoring seat 23.

Returning to FIG. 1, on the surface of the base plate 20 opposite the appendices 21, 22, a seat 27 is created in the form of a rectangular groove which extends for the whole length of the base plate.

In the groove 27 of the base plate 20 the supporting strip 5 is disposed so that the anchoring element 2 cannot rotate with respect to the supporting strip 5.

The base plate 20 has a suitable shape for the anchoring elements 2 to be fed automatically with a vibrating conveyor, which orients the anchoring elements 2 in the same direction and positions them in a suitable position to allow application of the strip 5.

The anchoring element 2 is constrained to the supporting strip 5 by means of a metal rivet 4 which passes through the supporting strip 5 and the base plate 20, to the side of the appendices 21 and 22 of the anchoring element 2.

The rivet 4 serves two functions:
a retaining function, because it prevents sliding and detachment of the anchoring element 2 from the supporting strip 5; and
a locating function, since it is magnetically attracted by the magnets disposed in suitable positions in the mould to position the anchoring elements 2 correctly.

Obviously in addition or instead of the attachment system described (grooved coupling and rivet), the anchoring element 2 can be fixed to the supporting strip 5 with other known fixing systems, such as welding, gluing, stapling and the like.

By way of example, between the supporting strip 5 and the base plate 20 of the anchoring element, a heat bond or heat-sealing 40 (FIGS. 3 and 4) is made from the other side with respect to the rivet 4. In this manner a perfect planar arrangement of the base plate 20 of the anchoring element on the strip 5 is ensured.

Furthermore the rivet 4 can be replaced by any other kind of metal element disposed in any other position on the supporting strip 5, to perform the function of coupling with the magnets of the mould. It should be noted that in any case the metal elements 4 disposed on the strip 5 are negligible in number and weight, making the foam material supporting body perfectly recyclable.

The supporting strip 5 is preferably flexible to be able to be bent and follow a non rectilinear profile. To this purpose the supporting strip 5 can be made of plastic material, such as, for example, polyethylene, polypropylene, polyamide, polyvinyl chloride (PVC), polyethylene terephthalate (PET) and the like, with a thickness ranging between 0.4 and 1 mm and a width ranging between 8 and 20 mm.

As shown in FIG. 3, the anchoring element 1 is provided in a rectilinear configuration, that is, a single supporting strip 5 to which a plurality of anchoring elements 2 are fixed.

If the hooks 2 must be disposed inside the mould following a non rectilinear course, a plurality of cuts 51 is made in the supporting strip 5, so as to divide the supporting strip 5 into a plurality of portions 5′ which can be bent along the cuts 51. In this manner, the supporting strip 5 can assume a desired non rectilinear profile, such as a polygonal broken line.

The supporting strip 5 can be maintained in said non-rectilinear configuration by applying, at the cuts 51, suitable fixing means 50, such as for example, heat-welding, gluing, stapling and the like. In FIG. 4, by way of example, an anchoring system 1 having a substantially U-shaped profile is obtained. Profiles with other shapes, such as, for example, L-, S-, N-shapes, etc. can be formed with said system.

In order to obtain more complex profiles, such as, for example, T-, E- and H-shapes, one or more portions 5′ of a suitable length can be removed from the supporting strip 5 by complete cutting. The portions 5′ are then fixed, in suitable positions, on the supporting strip 5, by means of the above-mentioned fixing means 50.

As shown in FIG. 5, the anchoring system 1 is disposed in a mould 6 for foaming. As a result, the metal rivets 4 of the anchoring system 1 couple magnetically with the magnets of the mould 6 and the anchoring system positions itself correctly inside the mould 6.

If the anchoring system 1 does not include metal rivets 4, in place of the magnets special seats 60 adapted to accommodate the supporting strip 5 are provided in the mould 6. Consequently, the supporting strip 5 positions itself correctly and the anchoring elements v position themselves correctly on the same plane.

At this point, a foamable material, such as polyurethane for example, is introduced into the mould and is left to reticulate so as to incorporate the anchoring system 1. In this manner, as shown in FIG. 6, a body of foam material 7 which incorporates the anchoring element 1 is extracted from the mould.

The body of foam material 7 is shaped as a seat or seat back and has a surface 70 destined to be covered with a sheet covering material 8. In the surface 70 of the foam material body 7, coinciding with the anchoring system 1, a groove 71 is provided which ends at the ends of the appendices 21, 22 of the anchoring elements 2 so that the anchoring elements 2 are sunk in the foam material and are also visible through the groove 71. Outside the appendices 21, 22 the groove 71 is deeper to leave a gap for the fastening element 9 and facilitate insertion.

The anchoring element 2 must be made of a plastic material such as polyethylene, polypropylene, polyamide, PVC, PET and the like, which does not adhere to the material, generally polyurethane foam, of the body 7.

The sheet covering material 8 has a loop 80 sewn thereto. A fastening element 9 in the form of a metal rod is inserted in the loop 80. The loop 80 has slits 81 to leave the fastening element 9 exposed.

To fix the covering 8 to the foam body 7, the fastening element 9 is inserted into the groove 71 of the foam body 7 and is forced by pressure at the entry 24 of the anchoring seat 23 of the anchoring elements 2.

The tapered wall 26 of the rib of the appendix 21 acts as a guide for the fastening element 9 and thus the pressure of the fastening element 9 parts the appendices 21 and 22 widening the opening 24, so that the fastening element 9 enters into the anchoring seat 23 (FIG. 7) and the appendices 21 and 22 elastically snap back into their original position, preventing the fastening element 9 from coming out.

It should be noted that in this situation the polyurethane foam that is situated in the anchoring seat 23 acts as a shock absorber for the fastening element 9, stabilizing it and avoiding annoying noises when the user is sitting.

In FIG. 8 a variant of the anchoring system 1 according to the invention is described, in which like or corresponding elements to those already described are denoted by the same reference numerals and are not described in detail.

In this variant two hooked appendices 21 facing each other are used, so as to form an anchoring seat 23 adapted to receive a fastening element 9 consisting of a V-shaped thickening of a strip 80 integral with the sheet covering material 8.

FIGS. 9 and 10 illustrate a second embodiment of the invention, in which the ferrous elements such as the rivet 4 and/or the clips 50 are replaced by metal microspheres 104 inserted in the supporting strip 5 and/or in the base 20 of the anchoring element 2. The metal microspheres are shot hot under pressure so as to penetrate at least partially into the supporting strip 5 and/or into the base 20 of the anchoring element 2, melting the material they meet and remaining incorporated therein. The microspheres are preferably inserted to coincide with each anchoring element, so as to penetrate partially also into the base 20 of the anchoring element. The sphere 104 must preferably emerge on the surface of the base 20 opposite the supporting strip 5 to be attracted by the magnet positioned in the mould on which it rests.

In this manner the base 20 of the anchoring element can be flat and can be fixed to the supporting strip 5 by means of welding 140, preferably ultrasound welding or arc welding. The various portions of supporting strip 5 also can be joined to each other by welding 140. Thus, the thickness of the supporting strip 5 can be reduced to a minimum.

In FIGS. 11 and 12 a third embodiment of the invention is illustrated, in which a metal rod 205 which is flattened in the positions in which the anchoring elements 2 are to be fixed is used as an attachment element, instead of the strip 5. For example, the flattened part of the rod 205 can have at least two planes 205a and 205b parallel to each other and vertical.

In this case, the anchoring element 2 has on the base two appendices 240 (FIG. 12) which define a vertical groove in which the flattened rod 205 is inserted. Then, the two appendices 240 are joined and welded to each other with the pressure of a hot V-shaped element, creating a small bridge of welded material 240′ (FIG. 1) around the flattened part 205a, 205b of the rod. In this manner any possibility of relative rotation of the anchoring elements 2 around the rod 205 is avoided.

It is obvious that the variant of the anchoring element 2 and of the fastening element 9 with a V-shaped thickening, illustrated in FIG. 8, can also be adapted to the second and third embodiments of the invention, illustrated in FIGS. 9-12.

Numerous variations and modifications of detail within the reach of a person skilled in the art can be made to the present embodiments of the invention, without thereby departing from the scope of the invention as set forth in the appended claims.

1-20. (canceled)

21. An apparatus comprising a mould having magnetic means and an anchoring system (1) for attaching a sheet material (8) to a mould-formed body (7), said anchoring system (1) comprising a plurality of anchoring elements (2) adapted to accommodate, in a snap coupling relationship, fastening means (9) made integral with said sheet material (8), and an attachment element (5; 205) to which said anchoring elements (2) are connected, characterised in that
said anchoring element (2) comprises a base plate (20) designed to be fixed to said attachment element (5; 205), and that from said base plate protrude two appendices (21, 22) which engender a snap anchoring seat (23) adapted to receive said fastening means (9) integral with said sheet material (8), and
said anchoring elements (2) and/or attachment element (5; 205) comprise ferrous material (4, 50; 104; 205) able to couple with said magnetic means carried by the forming mould, so that said anchoring system (1) can be correctly disposed in the mould and sunk into the foam material forming the body (7).

22. An apparatus according to claim 21, characterised in that said attachment element (5) is a supporting strip (5) to which said anchoring elements (2) are fixed in suitable positions.

23. An apparatus according to claim 22, characterised in that on said base plate (20) of the anchoring element (2) a groove (27) adapted to receive said supporting strip (5) is formed so as to avoid rotation of the anchoring element with respect to the supporting strip.

24. An apparatus according to claim 23, characterised in that said ferrous material comprises rivets (4) which fix said supporting strip (5) to said base plate (20) of the anchoring element (2).

25. An apparatus according to claim 23, characterised in that said ferrous material comprises metal microspheres (104) disposed at least partially in said supporting strip and/or in said anchoring elements.

26. An apparatus according to claim 22, characterised in that said anchoring elements (2) are fixed to said supporting strip (5) by means of welding, gluing or stapling.

27. An apparatus according to claim 22, characterised in that said supporting strip (5) is flexible and can be bent according to a desired profile.

28. An apparatus according to claim 22, characterised in that said supporting strip (5) is of plastic material, such as polyethylene, polypropylene, polyamide, poly-vinyl chloride (PVC), polyethylene terephthalate (PET) and the like, and has a thickness ranging between 0.4 and 1 mm and a width ranging between 8 and 20 mm.

29. An apparatus according to claim 22, characterised in that said supporting strip (5) has a plurality of cuts (51) defining a plurality of portions (51) which can be bent along said cuts (51), so as to form a non rectilinear profile, shaped as a polygonal broken line.

30. An apparatus according to claim 29, characterised in that in proximity to said cuts (51) in the supporting strip (5) fixing means (50) adapted to retain said portions (5′) of the supporting strip in said non rectilinear configuration are applied.

31. An apparatus according to claim 22, characterised in that it further comprises at least one portion (5′) cut from said supporting strip (5) and joined, in a suitable position, on said supporting strip (5), so as to form a non rectilinear path.

32. An apparatus according to claim 21, characterised in that said attachment element (205) is a metal rod (205) having flattened portions (205a, 205b) whereon said anchoring element (2) is blocked.

33. An apparatus according to claim 32, characterised in that said anchoring element comprises a bridge of material (240′), obtained by welding of two appendices (240) around said flattened portion (205a, 205b) of the rod (205).

34. A manufacturing method for an anchoring system (1) for attaching a sheet material (8) to a mould-formed body (7), comprising the following steps:
providing a plurality of anchoring elements (2) comprising a base plate (20) from which protrude two appendices (21, 22) which engender a snap anchoring seat (23) adapted to receive, in a snap coupling relationship, attachment means (9) made integral with said sheet material (8),
fixing the base plate (20) of said anchoring means (2) in suitable positions on an attachment element (5; 205),
applying ferrous material (4, 50; 104; 205) in suitable positions in the attachment element and/or in the anchoring elements;
positioning said attachment element (5) with the anchoring elements (2) in the mould, so that said ferrous material (4, 50; 104; 205) of the anchoring system can couple magnetically with magnets disposed in suitable positions in the mould; and
causing the foamable material to expand inside the mould to form said body (7) which incorporates the attachment element (5, 205) with the anchoring elements (2).

35. A method according to claim 34, characterised in that said step of applying ferrous material comprises the step of shooting metal microspheres (104) hot and under pressure into said attachment element and/or into the anchoring elements.

36. A method according to claim 34, characterised in that said attachment element (5) is a supporting strip (5) and the method further comprises the steps of:
making cuts (51) in said supporting strip so as to form a plurality of portions (5′) that can be bent along the cuts (51), and
bending the portions (5′) of the supporting strip along said cuts, so as to obtain a desired non rectilinear profile, shaped as a polygonal broken line.

37. A method according to claim 36, characterised in that it further comprises the step of applying fixing means (50) along said cuts (51) in the supporting strip, so as to retain the portions (51) of the supporting strip in said non rectilinear configuration.

38. A method according to claim 36, characterised in that it further comprises the step of cutting at least one portion (5′) from said supporting strip (5) and joining said at least one portion (5′), in a suitable position, on said supporting strip (5), so as to form a non rectilinear path.

39. A method according to claim 34, characterised in that said attachment element (205) is a metal rod (205) and the method further comprises the steps of flattening some portions (205a, 205b) of said rod and fixing said anchoring element (2) on said flattened portions (205a, 205b) of the rod.

40. A method according to claim 39, characterised in that said anchoring elements (2) are fixed by means of welding of two appendices (240) around said flattened portions (205a, 205b) of the rod.
